(19) United States
(12) Patent Application Publication
(10) Pub. No.: US 2026/0054944 A1
(43) Pub. Date: Feb. 26, 2026

(54) CONVEYING DEVICE

(71) Applicant: Toyo Tire Corporation, Itami-shi (JP)

(72) Inventors: Kazuma Hanafusa, Itami-shi (JP); Yoshito Nishiguchi, Itami-shi (JP)

(73) Assignee: Toyo Tire Corporation, Itami-shi (JP)

(21) Appl. No.: 19/289,472

(22) Filed: Aug. 4, 2025

(30) Foreign Application Priority Data
Aug. 20, 2024 (JP) 2024-139173

(51) Int. Cl. B65G 47/91

(52) U.S. Cl. CPC B65G 47/91

(57) ABSTRACT

Provided is a conveying device capable of suppressing suction mark generation even when a suction pad holds a tire component by suction. The conveying device includes an annular frame capable of surrounding an outer periphery of each of a first drum and second drum, and a suction unit provided to the annular frame, in which the suction unit includes a suction pad having a decompression space formed inside thereof and holding a tire component by suction, and multiple movement mechanisms moving the suction pad in a radial direction of the annular frame; and the suction pad includes a coupling portion coupled to the movement mechanism, a bellows portion protruding from the coupling portion, and a stopper protruding from the coupling portion to the decompression space and abutting on the tire component when the tire component is held by suction.

### BACKGROUND OF THE INVENTION

### 1. Field of the Invention

The present invention relates to a conveying device.

### 2. Description of Related Art

In a tire forming apparatus used to produce a pneumatic tire, a method in which tire components are prepared in parallel by division of labor using a plurality of drums and a conveying device has been known.

For example, there is a method in which a step of forming, on a band drum, a cylindrical band member including an inner liner and a carcass, a step of forming, on a belt drum, a cylindrical belt member including a belt, and a step of integrating the band member and the belt member and forming (shaping) same into a tire shape are performed at distinct stages, respectively, and delivery (that is, transfer) of tire components between the steps is performed using a conveying device.

As such a conveying device, for example, a conveying device having a movement unit for movement toward and away from a drum and a movement unit for transfer to a next step, in which a suction pad that holds, by suction from the outer diameter side, a cylindrical tire component wound around an outer periphery of a drum is provided with a movement mechanism has been known (for example, see JP2001-138404).

### SUMMARY OF THE INVENTION

However, in the conveying device of JP2001-138404, when the suction pad holds an outer peripheral surface of the cylindrical tire component by suction and conveys the tire component, the portion held by suction deforms, and a suction mark is likely to be generated on the tire component. When a suction mark is generated on the tire component, adhesion failure may occur in a subsequent step, or uniformity may deteriorate.

The present proposal has been made in view of the above circumstances, and an object is to provide a conveying device with which a suction mark is unlikely to be generated on a tire component even when a suction pad holds the tire component by suction.

The present invention includes aspects shown below.
[1] A conveying device receiving a cylindrical tire component formed on a first drum from the first drum and conveying the tire component to a second drum, the conveying device including an annular frame capable of surrounding an outer periphery of each of the first drum and the second drum, a suction unit provided to the annular frame, and a frame conveying unit conveying the annular frame between the first drum and the second drum, in which the suction unit includes a suction pad, a movement mechanism, and a decompression device, a decompression space is formed inside the suction pad, the suction pad holds the tire component by suction, the movement mechanism moves the suction pad in a radial direction of the annular frame, the decompression device decompresses the decompression space, the suction pad includes a pad main body and a stopper, the pad main body has a coupling portion coupled to the movement mechanism and a bellows portion protruding from the coupling portion, and the stopper protrudes from the coupling portion to the decompression space and abuts on the tire component when the tire component is held by suction.
[2] The conveying device according to item [1] above, in which the stopper has a tubular shape.
[3] The conveying device according to item [2] above, further including a communication hole allowing an internal cavity of the tubular stopper and a space decompressed by the decompression device to communicate with each other.
[4] The conveying device according to item [2] or [3] above, in which a through hole is provided on a peripheral wall of the stopper.
[5] The conveying device according to any one of items [1] to [4] above, in which the pad main body includes a skirt portion provided at a distal end of the bellows portion, and a distal end of the stopper is disposed on the bellows portion side from a joint portion between the skirt portion and the bellows portion in a protruding direction of the stopper.
[6] The conveying device according to item [5] above, in which the bellows portion is provided to be thicker than the skirt portion.
[7] The conveying device according to any one of items [1] to [6] above, in which a length in the protruding direction of the stopper from a distal end of the pad main body to the distal end of the stopper is 4 mm or more and 10 mm or less.
[8] The conveying device according to any one of items [1] to [7] above, in which the stopper is formed from a rubber material having a hardness of 30 or more and 60 or less.
[9] A conveying method of receiving a cylindrical tire component formed on a first drum from the first drum and conveying the tire component to a second drum using a conveying device including an annular frame capable of surrounding an outer periphery of each of the first drum and the second drum, a suction unit provided to the annular frame, and a frame conveying unit conveying the annular frame between the first drum and the second drum, in which the suction unit includes a suction pad, a movement mechanism, and a decompression device, a decompression space is formed inside the suction pad, the suction pad holds the tire component by suction, the movement mechanism moves the suction pad in a radial direction of the annular frame, the decompression device decompresses the decompression space, the suction pad includes a pad main body and a stopper, the pad main body has a coupling portion coupled to the movement mechanism and a bellows portion protruding from the coupling portion, the stopper protrudes from the coupling portion to the decompression space, and the tire component is received from the first drum by holding the tire component provided on the first drum with the suction pad by suction while causing the tire component to abut on the stopper.
[10] The conveying method according to item [9] above, in which after the pad main body and the stopper are caused to abut on the tire component, the decompression device decompresses the decompression space.
[11] The conveying method according to item [9] or above, in which a height of a suction mark formed, by the suction pad, on the tire component conveyed to the second drum is within 3 mm.

According to the present invention, by providing the above-described features, generation of a suction mark can be suppressed even when a suction pad holds a tire component by suction.

### BRIEF DESCRIPTION OF THE DRAWINGS

FIG. 1 is a plan view schematically illustrating a tire forming apparatus using a conveying device according to an embodiment of the present invention;

FIG. 2 is a cross-sectional view in an axial direction of a first drum, the cross-sectional view showing how tire components are bonded in a first drum of the embodiment;

FIG. 3 is a view of the conveying device according to an embodiment of the present invention as viewed from an axial direction of a tire component;

FIG. 4 is a cross-sectional view taken along a line A-A in FIG. 3;

FIG. 5 is a view of a suction pad and a movement mechanism viewed from an axial direction;

FIG. 6 is a cross-sectional view of the suction pad at a retracted position;

FIG. 7 is a cross-sectional view of the suction pad at a contact position;

FIG. 8 is a block diagram illustrating a control configuration of the conveying device according to an embodiment of the present invention; and

FIG. 9 is a flowchart showing control of the conveying device according to an embodiment of the present invention.

### DESCRIPTION OF EMBODIMENTS

Embodiments will be described with reference to drawings. Note that the embodiments described below are merely examples, and those appropriately modified without departing from the spirit of the present invention are included in the scope of the present invention.

### 1. Overall Configuration of Tire Forming Apparatus

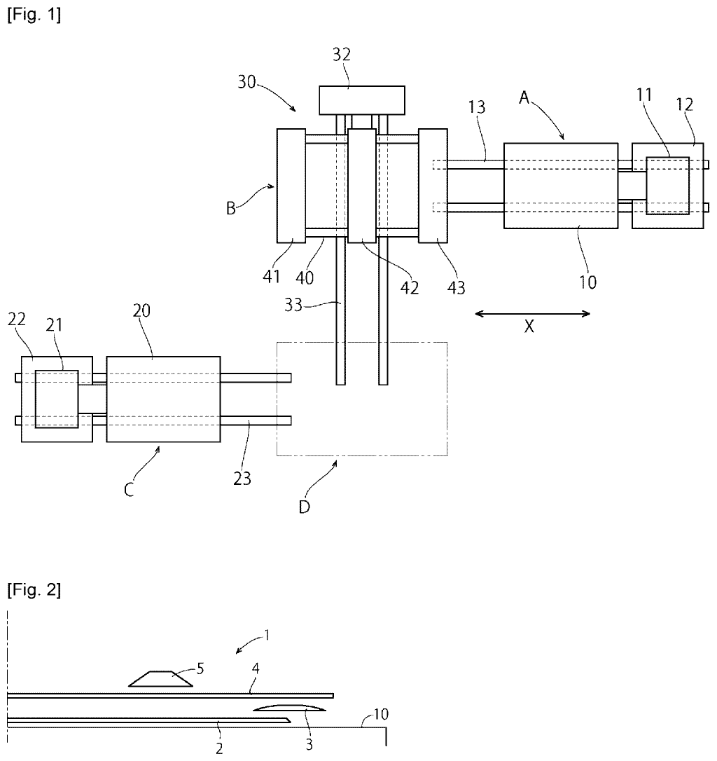

FIG. 1 illustrates a layout of a tire forming apparatus. The tire forming apparatus includes a first drum 10, a second drum 20, and a conveying device 30 that receives a tire component formed on an outer peripheral surface of the first drum 10 and conveys the tire component to the second drum 20.

The first drum 10 is a drum having a known structure in which a plurality of segments is circumferentially arranged to form a cylindrical shape as a whole. The outer peripheral surface of the first drum 10 expands or contracts in diameter as the plurality of segments simultaneously moves in the drum radial direction.

An unvulcanized rubber member is bonded to the outer peripheral surface of the first drum 10 to form a tire component 1. As an example, a case where a cylindrical carcass band is formed as the tire component 1 will be described. As shown in FIG. 2, first, an inner liner 2 is bonded to a central portion of the first drum 10 in an axial direction X. Thereafter, a rubber chafer 3 is bonded so as to overlap with a part of the inner liner 2 on each side in the axial direction X of the first drum 10. Thereafter, a carcass ply 4 is bonded to the central portion in the drum axial direction X so as to overlap with the inner liner 2 and the rubber chafer 3. The carcass ply 4 is a member in which many reinforcing cords arranged in a direction orthogonal to the tire circumferential direction are covered with rubber. A belt lower pad 5 is then bonded to each end portion in the axial direction of the first drum 10. The belt lower pad 5 is provided at a position away from the center in the axial direction X of the first drum 10 by a predetermined distance so as to be located at a position where an end portion of a belt is disposed in a later step. In this manner, the carcass band (tire component) 1 including the inner liner 2, the rubber chafer 3, the carcass ply 4, and the belt lower pad 5 is completed. In the tire component 1, a portion in which the belt lower pad 5 is provided has a larger rubber thickness than the other portions, and bulges outward in the radial direction of the first drum 10. The portion that bulges outward in the radial direction of the first drum 10 is formed continuously in the circumferential direction of the first drum 10 (see FIG. 4).

A rotation shaft of the first drum 10 is supported by a support base 11. The support base 11 is mounted on a first drum conveying unit 12 that moves along a rail described later.

The second drum 20 is a drum to which the tire component 1 formed on the first drum 10 is conveyed. For example, the tire component 1 is conveyed to the second drum 20, and a cylindrical belt band formed on a drum (not shown) is conveyed to the second drum 20. The second drum 20 is a drum for forming these conveyed bands into a tire shape.

A rotation shaft of the second drum 20 is supported by a support base 21. The support base 21 is mounted on a second drum conveying unit 22 that moves along a rail described later.

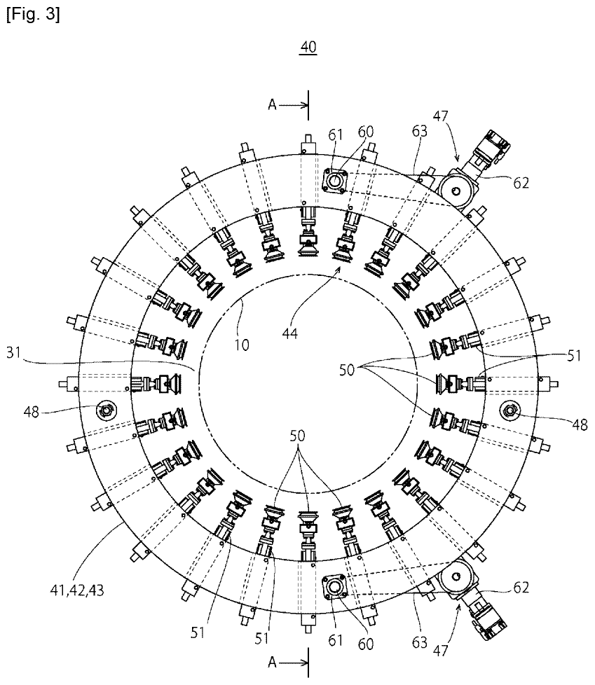

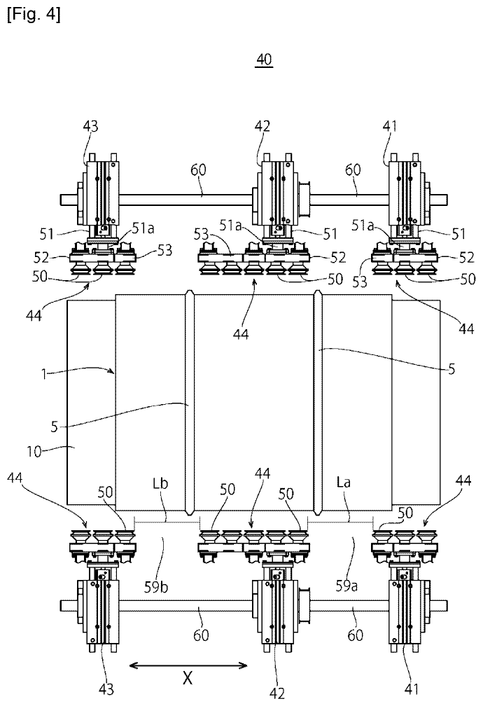

The conveying device 30 includes a hollow portion 31 (see FIG. 3) into which the first drum 10 or the second drum 20 is inserted. The conveying device 30 receives the cylindrical tire component 1 from the first drum 10 inserted into the hollow portion 31. When the second drum 20 is inserted into the hollow portion 31 after the first drum 10 is removed from the hollow portion 31, the conveying device 30 transfers the tire component 1 received from the first drum 10 to an outer peripheral surface of the second drum 20. A specific configuration of the conveying device 30 will be described later in detail.

A first rail 13, a second rail 23, and a third rail 33 are provided as rails along which the first drum 10, the second drum 20, and the conveying device 30 move. The first rail 13 and the second rail 23 are linear rails arranged in parallel to each other. The third rail 33 is a linear rail and is perpendicular to the extending direction of the first rail 13 and the second rail 23.

With respect to the first drum 10, the first drum 10 moves between a standby position (indicated by A in FIG. 1) and an intersecting portion (indicated by B in FIG. 1) with the third rail 33 as the first drum conveying unit 12 moves on the first rail 13.

With respect to the second drum 20, the second drum 20 moves between a standby position (indicated by C in FIG. 1) and an intersecting portion (indicated by D in FIG. 1) with the third rail 33 as the second drum conveying unit 22 moves on the second rail 23.

The conveying device 30 moves between the intersecting portion B and the intersecting portion D as a frame conveying unit 32 described later moves on the third rail 33. After receiving the tire component 1 from the first drum 10 at the intersecting portion B, the conveying device 30 moves to the intersecting portion D and delivers the tire component 1 to the second drum 20 at the intersecting portion D.

The first drum 10, the second drum 20, and the conveying device 30 are disposed so that the axial directions X thereof are oriented in the same direction. The axial directions X of the drums 10 and 20 and the conveying device 30 are parallel to the extending direction of the first rail 13 and the second rail 23.

### 2. Conveying Device 30

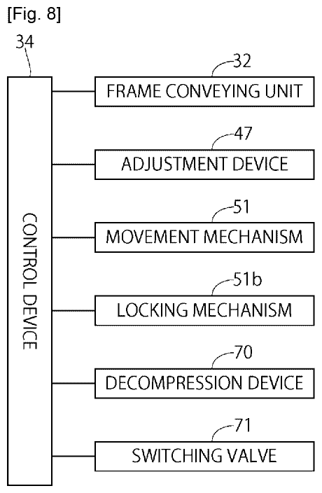

As illustrated in FIG. 1 and FIG. 8, the conveying device 30 includes a holding device 40 that holds an outer peripheral surface of the tire component 1, the frame conveying unit 32 that moves the holding device 40 along the third rail 33, and a control device 34 that controls the holding device 40 and the frame conveying unit 32.

As illustrated in FIG. 1, FIG. 3, and FIG. 4, the holding device 40 includes a plurality of (three in the present embodiment) annular frames 41, 42, and 43, suction units 44, 44, and 44 provided to the respective annular frames 41, 42, and 43, and an adjustment device 47 that moves the annular frames 41 and 43 in the axial direction X.

The annular frames 41, 42, and 43 are ring-shaped members each having a hollow space and capable of surrounding the outer periphery of each of the first drum 10 and the second drum 20. The annular frames 41, 42, and 43 are concentrically arranged at intervals in the axial direction X to form the hollow portion 31 of the conveying device 30.

As illustrated in FIG. 4, the annular frames 41 and 43 are end annular frames disposed at both end portions in the axial direction. The annular frame 42 is a central annular frame disposed between the end annular frames 41 and 43.

The central annular frame 42 is provided with the suction unit 44. As illustrated in FIG. 4, the suction unit 44 includes a plurality of suction pads 50 holding the outer peripheral surface of the tire component 1 by suction, a plurality of movement mechanisms 51 moving the plurality of suction pads 50 in a radial direction of the central annular frame 42, and a decompression device 70.

Specifically, the suction pads 50 are central suction pads holding, by suction, the central portion of the tire component 1 in the axial direction. The suction pads 50 are arranged at intervals in the circumferential direction of the central annular frame 42 as illustrated in FIG. 3, and are arranged side by side at intervals in the axial direction X as illustrated in FIG. 4.

The suction pads 50 arranged side by side in the axial direction X are supported by a support unit 52 connected to the same movement mechanism 51. On the other hand, the suction pads 50 adjacent to each other in the circumferential direction of the central annular frame 42 are supported by support units 52 connected to different movement mechanisms 51.

That is, the suction pads 50 provided side by side in the axial direction X move in the radial direction of the central annular frame 42 in synchronization with each other by an operation of the same movement mechanism 51. On the other hand, the suction pads 50 provided at different positions in the circumferential direction are movable separately in the radial direction of the central annular frame 42 by different movement mechanisms 51 from one another.

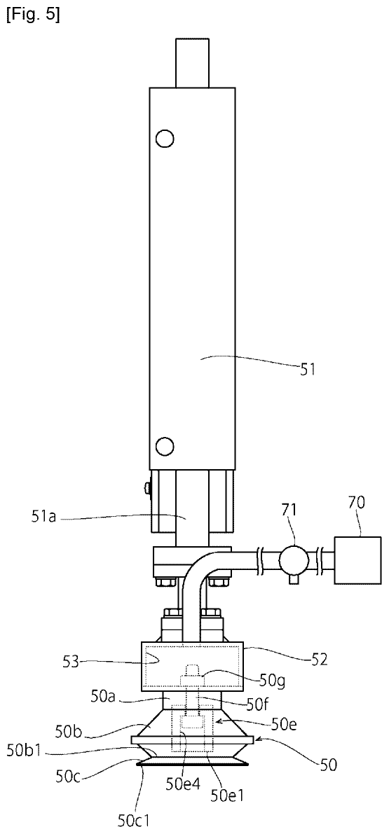

As illustrated in FIG. 4 to FIG. 6, a vacuum chamber 53 is formed inside the support unit 52. The vacuum chamber 53 is connected to the decompression device 70 via a switching valve 71. Upon receiving an instruction from the control device 34, the switching valve 71 switches between a flow path communicating between the vacuum chamber 53 and the decompression device 70 and a flow path communicating between the vacuum chamber 53 and an external space of the vacuum chamber 53. As the switching valve 71 switches the flow path in this manner, the decompression device 70 decompresses the vacuum chamber 53 or brings the pressure inside the vacuum chamber 53 to atmospheric pressure.

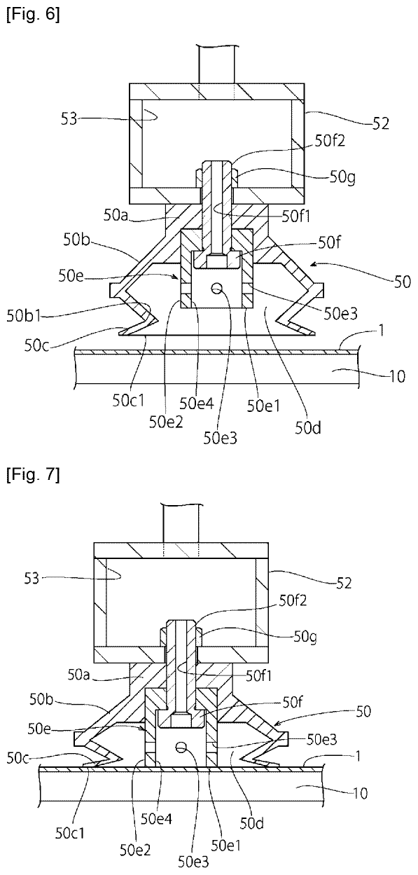

As illustrated in FIG. 6 and FIG. 7, the suction pad 50 includes a substantially cylindrical coupling portion 50a coupled to the support unit 52, a bellows portion 50b protruding from a peripheral edge portion of the coupling portion 50a, a skirt portion 50c provided at a distal end of the bellows portion 50b, and a stopper 50e attached to a central portion of the coupling portion 50a.

The coupling portion 50a, the bellows portion 50b, and the skirt portion 50c of the suction pad 50 constitute a pad main body, and are integrally formed from an elastic material such as a urethane-based or silicon-based elastomer or rubber, for example. A decompression space 50d is formed on the inner side of the coupling portion 50a, the bellows portion 50b, and the skirt portion 50c and opens radially inward of the central annular frame 42 (hereinafter, this direction is sometimes referred to as a downward direction).

In the present embodiment, the skirt portion 50c provided at the distal end of the bellows portion 50b has a shape expanding downward so that an opening portion to the decompression space 50d becomes larger toward the distal end. The bellows portion 50b is provided to be thicker than the skirt portion 50c, and the skirt portion 50c is more likely to bend and deform than the bellows portion 50b immediately after the tire component 1 comes into contact with the skirt portion 50c.

Although a case where the pad main body has the coupling portion 50a, the bellows portion 50b, and the skirt portion 50c is described in the present embodiment, the pad main body may be composed of the coupling portion 50a and the bellows portion 50b, and the pad main body may not be provided with a skirt portion.

The stopper 50e is provided so as to protrude from the central portion of the coupling portion 50a to the decompression space 50d (that is, so as to protrude from the central portion of the coupling portion 50a downwardly). In the present embodiment, the stopper 50e forms a tubular shape (for example, a cylindrical shape) open at the bottom.

As illustrated in FIG. 6, in a state where the tire component 1 is not in contact with the pad main body, a distal end (lower end) 50e1 of the stopper 50e is located radially outward of the central annular frame (hereinafter, this direction is sometimes referred to as an upward direction) from the lower end of the pad main body. When the pad main body is provided with the skirt portion 50c as in the present embodiment, the distal end 50e1 of the stopper 50e is located above a lower end 50c1 of the skirt portion 50c in a state where the tire component 1 is not in contact with the skirt portion 50c. The distal end 50e1 of the stopper 50e is preferably located above (on the bellows portion 50b side of) a joint portion 50b1 between the bellows portion 50b and the skirt portion 50c in the radial direction (hereinafter, this direction is sometimes referred to as a vertical direction) of the central annular frame 42 corresponding to the protruding direction of the stopper 50e.

The length along the vertical direction (protruding direction of the stopper 50e) from the lower end (lower end 50c1 of the skirt portion 50c in the present embodiment) of the pad main body to the distal end 50e1 of the stopper 50e is not particularly limited but is preferably 4 mm or more and 10 mm or less, and more preferably 6 mm or more and 8 mm or less, for example.

A peripheral wall 50e2 of the stopper 50e is provided with a through hole 50e3. The through hole 50e3 communicates an internal cavity 50e4 formed inside the stopper 50e with the decompression space 50d formed outside the stopper 50e. In the present embodiment, the through hole 50e3 is provided on the peripheral wall 50e2 so as not to open at the bottom of the peripheral wall 50e2. In other words, the distal end 50e1 of the stopper 50e is connected annularly.

The stopper 50e is formed from a rubber material such as silicone rubber or urethane rubber. From the viewpoint that damage to the tire component 1 due to contact with the stopper 50e can be suppressed, the hardness of the stopper 50e is preferably 30 or more and 60 or less, for example. The hardness of the stopper 50e is durometer hardness defined in section 3. 2 of JIS K6253-1-2012 and is measured by using a type A durometer for general-purpose rubber (medium hardness) in an atmosphere of 23° C. The stopper 50e may be a material different from the coupling portion 50a, the bellows portion 50b, and the skirt portion 50c, or the same material as the coupling portion 50a, the bellows portion 50b, or the skirt portion 50c.

The above-described stopper 50e is fixed to the coupling portion 50a by an attachment member 50f. A male threaded portion 50f2 is formed on one end side of the attachment member 50f. The attachment member 50f is inserted into the internal cavity 50e4 of the stopper 50e from below. The male threaded portion 50f2 penetrates the stopper 50e, the coupling portion 50a, and the support unit 52 and protrudes into the vacuum chamber 53 formed inside the support unit 52. A nut 50g is screwed to a portion of the male threaded portion 50f2 protruding into the vacuum chamber 53. Consequently, the stopper 50e and the coupling portion 50a are fastened together to the support unit 52 with the nut 50g.

A communication hole 50f1 is formed in the attachment member 50f along the axial direction. The internal cavity 50e4 of the stopper 50e communicates with the vacuum chamber 53, which is a space decompressed by the decompression device 70, through the communication hole 50f1 provided in the attachment member 50f. When the decompression device 70 decompresses the vacuum chamber 53, the decompression space 50d provided inside the suction pad 50 and the internal cavity 50e4 of the stopper 50e are decompressed via the communication hole 50f1 of the attachment member 50f. Consequently, the suction pad 50 holds by vacuum suction the central portion of the outer peripheral surface of the tire component 1 in the axial direction.

The movement mechanism 51 includes a cylinder in which a rod 51a moves in the radial direction (vertical direction) of the central annular frame 42. Upon receiving an instruction from the control device 34, the movement mechanism 51 moves the rod 51a to an arbitrary position within a movable range of the rod 51a. In addition, the movement mechanism 51 is provided with a locking mechanism 51b for fixing the rod 51a so that the position of the rod 51a is not changed (see FIG. 8).

The support unit 52 is fixed to the rod 51a of the movement mechanism 51 described above. The movement mechanism 51 moves the rod 51a in the vertical direction, and the suction pad 50 thus moves between a position (retracted position) spaced radially outward from the tire component 1 provided on the outer peripheral surface of the first drum 10 and a position (contact position) in contact with the tire component 1, as illustrated in FIG. 6. The contact position is set at a position at which at least the skirt portion 50c comes into contact with the tire component 1. As illustrated in FIG. 7, the contact position is preferably set at a position at which the skirt portion 50c and the distal end 50e1 of the stopper 50e come into contact with the tire component 1.

The suction units 44 and 44 holding the outer peripheral surface of the tire component 1 are provided to the end annular frames 41 and 43. The suction units 44 and 44 provided to the end annular frames 41 and 43 hold end portions of the tire component 1 in the axial direction by suction. Although the positions at which the tire component 1 is held by suction differ, the suction units 44 and 44 provided to the end annular frames 41 and 43 have the same structure as the suction unit 44 provided to the central annular frame 42. Therefore, the suction units 44 and 44 provided to the end annular frames 41 and 43 are denoted by the same reference numeral as the suction unit 44 of the central annular frame 42, and description thereof is omitted.

In the present embodiment, when the holding device 40 is viewed from the axial direction X as illustrated in FIG. 3, the suction pad 50 provided to the central annular frame 42 is disposed so as to overlap with the suction pads 50 provided to the end annular frames 41 and 43.

The end annular frames 41 and 43 each provided with the suction unit 44 as described above are coupled to a guide shaft 48 fixed to the central annular frame 42 via a bearing (not shown). Consequently, the end annular frames 41 and 43 can move close to and away from the central annular frame 42 in the axial direction X. As illustrated in FIG. 4, a gap 59a extending in parallel to the axial direction X is formed between the suction pad 50 provided to the central annular frame 42 and the suction pad 50 provided to the end annular frame 41 in a state where the end annular frames 41 and 43 are coupled to the central annular frame 42. A gap 59b extending in parallel to the axial direction X is formed between the suction pad 50 provided to the central annular frame 42 and the suction pad 50 provided to the end annular frame 43.

As illustrated in FIG. 3, the adjustment device 47 provided to each of the end annular frames 41 and 43 includes a screw shaft 60 disposed parallel to the guide shaft 48, an attachment bracket 61 having a screw hole into which the screw shaft 60 is screwed, and a driving unit 62 for rotating the screw shaft 60 about the axis. As the driving unit 62 rotates the screw shaft 60 about the axis via a driving belt 63, the adjustment device 47 slidingly moves the end annular frames 41 and 43 fixed to the attachment bracket 61 together with the attachment bracket 61 in the axial direction X. Consequently, lengths La and Lb in the axial direction X of the gap 59a and the gap 59b described above are changed.

In the present embodiment, the adjustment device 47 moves one end annular frame 41 and the other end annular frame 43 in synchronization with each other in directions opposite to each other in the axial direction X. That is, the adjustment device 47 moves the one end annular frame 41 and the other end annular frame 43 close to or away from the central annular frame 42 by the same distance, and moves the end annular frames 41 and 43 so that the gap 59a and the gap 59b described above are equal to each other.

The control device 34 is mainly composed of a microcomputer and controls an overall operation of the conveying device 30. The control device 34 controls the frame conveying unit 32, the adjustment device 47, the movement mechanism 51, the locking mechanism 51b thereof, the switching valve 71, and the decompression device 70 that decompresses the vacuum chamber 53.

### 3. Operation of Conveying Device 30

Next, an operation in which the conveying device 30 receives the cylindrical tire component 1 formed on the first drum 10 and conveys the cylindrical tire component 1 to the second drum 20 will be described.

First, the conveying device 30 sets a range in which the movement mechanism 51 of the suction unit 44 moves the rod 51a according to the size of the tire component 1 formed on the outer peripheral surface of the first drum 10. That is, the range in which the rod 51a of the movement mechanism 51 moves is set so that the suction pads 50 provided to the central annular frame 42 and the end annular frames 41 and 43 move between the retracted position separated radially outward from the tire component 1 and the contact position in contact with the tire component 1.

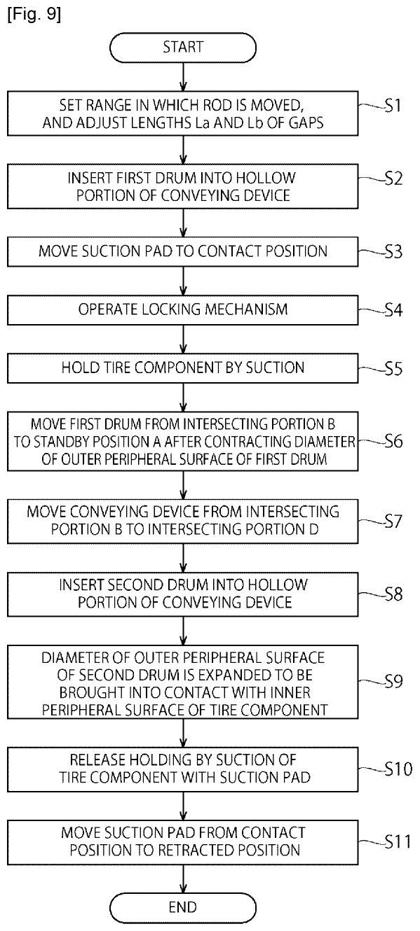

The adjustment device 47 changes the positions of the end annular frames 41 and 43 in the axial direction X with respect to the central annular frame 42 to adjust the lengths La and Lb of the gaps 59a and 59b so that the belt lower pad 5 provided on the tire component 1 is located in the gaps 59a and 59b formed between the suction pad 50 provided to the central annular frame 42 and the suction pads 50 provided to the end annular frames 41 and 43, when the first drum 10 moves to the hollow portion 31 of the conveying device 30 (Step S1 in FIG. 9).

The setting of the range in which the movement mechanism 51 moves the rod 51a and the adjustment of the lengths La and Lb of the gaps 59a and 59b are performed when the size and type of a tire to be manufactured are changed, and do not need to be performed each time the tire component 1 is conveyed.

The first drum 10 with the tire component 1 formed on the outer peripheral surface thereon is then moved to the intersecting portion B in a state where the conveying device 30 is located in the intersecting portion B and where the suction pad 50 is located at the retracted position, and the first drum 10 is inserted into the hollow portion of the conveying device 30 (Step S2 in FIG. 9). In the present embodiment, the first drum 10 is inserted into the hollow portion of the conveying device 30 so that the central portion of the tire component 1 in the axial direction X coincides, in the axial direction X, with the central portion in the axial direction X of the suction unit 44 provided to the central annular frame 42 (see FIG. 4).

As described above, the retracted position and the contact position for the suction pad 50 are set according to the size of the tire component 1 in the conveying device 30. In addition, the gaps 59a and 59b formed between the suction pad 50 provided to the central annular frame 42 and the suction pads 50 provided to the end annular frames 41 and 43 are also set according to the size of the tire component 1. When the first drum 10 is inserted into the hollow portion 31 of the conveying device 30, the suction pad 50 of the suction unit 44 faces the tire component 1 provided on the outer peripheral surface of the first drum 10, with an interval provided therebetween on the outer side in the radial direction. In addition, the belt lower pad 5 provided on the tire component 1 is disposed at positions in the gaps 59a and 59b of the conveying device 30 in the axial direction X.

Thereafter, the movement mechanism 51 moves the suction pad 50 from the retracted position to the contact position. In the present embodiment, when the suction pad 50 moves to the contact position, the skirt portion 50c of the suction pad 50 and the distal end 50e1 of the stopper 50e come into contact with the tire component 1 as illustrated in FIG. 7 (Step S3 in FIG. 9). When the suction pad 50 moves from the retracted position to the contact position, the switching valve 71 communicates the vacuum camber 53 with the external space, making the pressure in the decompression space 50d of the suction pad 50 atmospheric pressure.

The belt lower pad 5 provided on the tire component 1 is disposed at the positions in the gaps 59a and 59b of the conveying device 30. Therefore, the suction pad 50 provided to the central annular frame 42 comes into contact with the tire component 1 on the inner side (on the side closer to the center in the axial direction X than the belt lower pad 5) of the belt lower pad 5. The suction pads 50 provided to the end annular frames 41 and 43 come into contact with the tire component 1 on the outer side (on the side closer to an end portion in the axial direction X than the belt lower pad 5) of the belt lower pad 5. That is, the suction pad 50 comes into contact with the tire component 1 while avoiding the belt lower pad 5.

Although the case where when the suction pad 50 moves to the contact position, the skirt portion 50c and the distal end 50e1 of the stopper 50e come into contact with the tire component 1 is described in the present embodiment, the suction pad 50 may be disposed such that the distal end 50e1 of the stopper 50e is separated from the tire component 1, and the skirt portion 50c comes into contact with the tire component 1.

When the suction pad 50 moves to the contact position and comes into contact with the tire component 1, the locking mechanism of the movement mechanism 51 is brought into operation to fix the position of the rod 51a of the movement mechanism 51, preventing the position of the suction pad 50 from changing (Step S4 in FIG. 9).

The switching valve 71 is then switched so that the vacuum chamber 53 and the decompression device 70 communicate with each other to decompress the vacuum chamber 53. Consequently, the decompression space 50d of the suction pad 50 and the internal cavity 50e4 of the stopper 50e are decompressed, and the suction pad 50 holds the tire component 1 by suction (Step S5 in FIG. 9). In the present embodiment, since the distal end 50e1 of the stopper 50e comes in contact with the tire component 1 before the suction pad 50 holds the tire component 1 by suction, the tire component 1 is unlikely to be drawn into the decompression space 50d even when the suction pad 50 holds the tire component 1 by suction.

The outer peripheral surface of the first drum 10 is then contracted in diameter, and the first drum 10 is subsequently moved from the intersecting portion B to the standby position A to deliver the tire component 1 from the first drum 10 to the conveying device 30 (Step S6 in FIG. 9).

The conveying device 30 is then moved from the intersecting portion B to the intersecting portion D in a state where the second drum 20 is disposed at the standby position C (Step S7 in FIG. 9).

The second drum 20 is then moved from the standby position C to the intersecting portion D to insert the second drum 20 into the hollow portion 31 of the conveying device 30 (Step S8 in FIG. 9). The outer peripheral surface of the second drum 20 contracts in diameter during movement from the standby position C to the intersecting portion D, and is made smaller than the inner diameter of the tire component 1.

The outer peripheral surface of the second drum 20 is then expanded to be brought into contact with an inner peripheral surface of the tire component 1, causing the second drum 20 to hold the tire component 1 (Step S9 in FIG. 9).

The decompression of the vacuum chamber 53 by the decompression device 70 is then stopped to release the holding by suction of the tire component 1 by the suction pad 50 (Step S10 in FIG. 9).

The movement mechanism 51 then moves the suction pad 50 from the contact position to the retracted position to deliver the tire component 1 to the second drum 20 (Step S11 in FIG. 9).

The heigh of a suction mark due to the suction pad 50 formed on the tire component 1 conveyed from the first drum 10 to the second drum 20 is preferably within 3 mm.

### 4. Effects

In the preset embodiment, since the suction pad 50 includes the stopper 50e protruding from the coupling portion 50a to the decompression space 50d, even when the decompression space 50d is decompressed to hold the tire component 1 by suction, the tire component 1 abuts on the stopper 50e to prevent the tire component 1 from being excessively drawn into the decompression space 50d. Therefore, even in a case of the tire component 1 which is formed from unvulcanized rubber and easily deforms, a suction mark is unlikely to be generated on the tire component 1.

In addition, in the present embodiment, since the stopper 50e has a tubular shape open at the bottom, the stopper 50e is allowed to abut on the tire component 1 while ensuring a region where the suction pad 50 holds the tire component 1 by suction. Therefore, in the present embodiment, generation of a suction mark can be suppressed while securing high suction force.

In addition, in the present embodiment, since the internal cavity 50e4 of the stopper 50e communicates with the vacuum chamber 53 decompressed by the decompression device 70 via the communication hole 50f1, the tire component 1 can be held by suction in the internal cavity 50e4 of the stopper 50e, and high suction force is likely to be obtained.

In particular, since the through hole 50e3 is provided on the peripheral wall 50e2 of the stopper 50e, even after the tire component 1 abuts on the distal end 50e1 of the stopper 50e, the inner side and the outer side of the stopper 50e communicate with each other via the communication hole 50f1, and the tire component 1 can be held by suction on the inner and outer sides of the stopper 50e.

Moreover, in the present embodiment, the through hole 50e3 is provided on the peripheral wall 50e2 so as not to open at the bottom of the peripheral wall 50e2, and the distal end 50e1 of the stopper 50e is connected annularly. Therefore, even when the tire component 1 includes many reinforcing cords, the reinforcing cords are less likely to be locally drawn into the decompression space 50d side, and the tire component 1 can be held while maintaining a state where the reinforcing cords are uniformly arranged.

In the present embodiment, in the case where the distal end 50e1 of the stopper 50e is located at a position closer to the bellows portion 50b than the joint portion 50b1 between the bellows portion 50b and the skirt portion 50c, when the skirt portion 50c is brought into contact with the tire component 1, the surface pressure at the contact portion between the skirt portion 50c and the tire component 1 can be increased, and sealability of the decompression space 50d can be improved.

Furthermore, in the case where the bellows portion 50b is provided to be thicker than the skirt portion 50c, when the skirt portion 50c is brought into contact with the tire component 1, adhesion with the tire component 1 can be improved in the skirt portion 50c. In addition, large restoring force can be generated in the bellows portion 50b, and the surface pressure exerted by the skirt portion 50c on the tire component 1 can thus be increased. As a result, sealability of the decompression space 50d can be further improved.

### 5. Examples and Comparative Example

With respect to a suction pad used in a conveying device of each of Examples and Comparative Example, the suction force for holding the tire component 1 and the height of a suction mark generated on the tire component 1 after being conveyed were measured.

Example 1 is a suction pad in which a stopper formed from silicone rubber is attached to a pad main body formed from urethane rubber. The decompression space of the pad main body is provided with an opening with a diameter of 50 mm. The stopper has a cylindrical shape with an outer diameter of 20 mm and an inner diameter of 14 mm. In Example 1, the length P of the stopper 50e in the protruding direction from the lower end 50c1 of the skirt portion 50c to the distal end 50e1 of the stopper 50e was set to 0 mm, and the lower end 50c1 of the skirt portion 50c and the distal end 50e1 of the stopper 50e were set to be positioned in the same plane.

Examples 2 to 7 are each a suction pad same as that of Example 1 except that the length P of the stopper 50e in the protruding direction from the lower end 50c1 of the skirt portion 50c to the distal end 50e1 of the stopper 50e was changed as shown in Table 1.

Comparative Example is a suction pad same as that of Example 1 except that no stopper is provided.

A tire component fixed to an outer peripheral surface of a drum with a diameter of 555 mm was held by suction using the suction pad of each of Examples 1 to 7 and Comparative Example, the tensile load at the time of suction was measured with a tensile tester, and the measured value was defined as the suction force.

In addition, a tire component fixed to an outer peripheral surface of a drum with a diameter of 555 mm was held by suction using the suction pad of each of Examples 1 to 7 and Comparative Example, the suction was maintained for 60 seconds, and the suction of the tire component with the suction pad was then released. The height of a suction mark formed on the tire component by each suction pad was then measured. The measured suction force and height of the suction mark in each of Examples 1 to 7 and Comparative Example are shown in Table 1.

TABLE 1

| | Ex. | Ex. | Ex. | Ex. | Ex. | Ex. | Ex. | Comp. |
|---|---|---|---|---|---|---|---|---|
| | 1 | 2 | 3 | 4 | 5 | 6 | 7 | Ex. |
| Length P in | 0 | 2 | 4 | 6 | 8 | 10 | 12 | — |
| protruding | | | | | | | | |
| direction | | | | | | | | |
| (mm) | | | | | | | | |
| Suction force | 28.5 | 42.1 | 46.9 | 46.9 | 36.4 | 30.4 | 22.3 | 42 |
| (N) | | | | | | | | |
| Height of | 0 | 0 | 0 | 0 | 0 | 0 | 0 | 4 |
| suction mark | | | | | | | | |
| (mm) | | | | | | | | |

As shown in Table 1, the height of the suction mark was 4 mm in Comparative Example, and adhesion failure and deterioration of uniformity occurred in a subsequent step. On the other hand, in Examples 1 to 7, the height of the suction mark was 0 mm, not causing adhesion failure and deterioration of uniformity in a subsequent step.

In addition, in Examples 1 to 7, the suction force was 20 N or more, and suction force sufficient to hold the tire component was obtained.

### REFERENCE SIGNS LIST

1: Tire component
10: First drum
11: Support base
12: First drum conveying unit
13: First rail
20: Second drum
21: Support base
22: Second drum conveying unit
23: Second rail
30: Conveying device
31: Hollow portion
32: Frame conveying unit
33: Third rail
34: Control device
40: Holding device
41: End annular frame
42: Central annular frame
43: End annular frame
44: Suction unit
47: Adjustment device
48: Guide shaft
50: Suction pad
50a: Coupling portion
50b: Bellows portion
50b1: Joint portion
50c: Skirt portion
50c1: Lower end
50d: Decompression space
50e: Stopper
50e1: Lower end
50e2: Peripheral wall
50e3: Through hole
50e4: Internal cavity
50f: Attachment member
50f1: Communication hole 50f2: Male threaded portion 50g: Nut 51: Movement mechanism 51a: Rod 51b: Locking mechanism 52: Support unit 53: Vacuum chamber 70: Decompression device

What is claimed is:

1. A conveying device receiving a cylindrical tire component formed on a first drum from the first drum and conveying the tire component to a second drum, the conveying device comprising:
an annular frame capable of surrounding an outer periphery of each of the first drum and the second drum;
a suction unit provided to the annular frame; and
a frame conveying unit conveying the annular frame between the first drum and the second drum, wherein
the suction unit includes a suction pad, a movement mechanism, and a decompression device, wherein a decompression space is formed inside the suction pad, the suction pad holds the tire component by suction, the movement mechanism moves the suction pad in a radial direction of the annular frame, and the decompression device decompresses the decompression space; and
the suction pad includes a pad main body and a stopper, wherein the pad main body has a coupling portion coupled to the movement mechanism and a bellows portion protruding from the coupling portion, and the stopper protrudes from the coupling portion to the decompression space and abuts on the tire component when the tire component is held by suction.

2. The conveying device according to claim 1, wherein the stopper has a tubular shape.

3. The conveying device according to claim 2, further comprising a communication hole allowing an internal cavity of the tubular stopper and a space decompressed by the decompression device to communicate with each other.

4. The conveying device according to claim 3, wherein a through hole is provided on a peripheral wall of the stopper.

5. The conveying device according to claim 1, wherein
the pad main body includes a skirt portion provided at a distal end of the bellows portion, and
a distal end of the stopper is disposed on the bellows portion side from a joint portion between the skirt portion and the bellows portion in a protruding direction of the stopper.

6. The conveying device according to claim 5, wherein the bellows portion is provided to be thicker than the skirt portion.

7. The conveying device according to claim 1, wherein a length in the protruding direction of the stopper from a distal end of the pad main body to the distal end of the stopper is 4 mm or more and 10 mm or less.

8. The conveying device according to claim 1, wherein the stopper is formed from a rubber material having a hardness of 30 or more and 60 or less.
